(19) United States
(12) Patent Application Publication
(10) Pub. No.: US 2025/0179328 A1
(43) Pub. Date: Jun. 5, 2025

(54) THERMOFORMABLE PAINT FILMS

(71) Applicant: 3M INNOVATIVE PROPERTIES COMPANY, St. Paul, MN (US)

(72) Inventors: Yongshang Lu, Woodbury (MN); Ken Egashira, Kanagawa (JP); Charlie C. Ho, Woodbury, MN (US); Jay M. Jennen, Forest Lake, MN (US); Todd G. Pett, St. Paul, MN (US); David P. Siglin, St. Paul, MN (US); Tong Wei, Woodbury, MN (US)

(21) Appl. No.: 18/691,067

(22) PCT Filed: Aug. 16, 2022
(86) PCT No.: PCT/IB2022/057672

§ 371 Date: Mar. 12, 2024

Related U.S. Application Data
(60) Provisional application No. 63/244,868, filed on Sep. 16, 2021.

(51) Int. Cl. C09D 175/06; B29C 51/10; B29C 51/14; B29L 31/30; B32B 7/06; B32B 7/12; B32B 27/20; B32B 27/40; C09D 5/26

(52) U.S. Cl. CPC C09D 175/06; B32B 7/06; B32B 7/12; B32B 27/20; B32B 27/40; C09D 5/26; B29C 51/10; B29C 51/14; B29L 2031/30

(57) ABSTRACT

Described herein is a multilayered paint film, which comprises in order: (i) a hard coat layer comprising a thermoplastic polyurethane having a hard segment content of 80 percent by weight or greater, wherein the thermoplastic polyurethane is a reaction product of: (a) a diisocyanate; (b) a polyol optionally comprising a cyclic structure; and (c) a chain extender, wherein at least one of the polyol or the chain extender comprises at least one side chain and at least one of the diisocyanate or the chain extender comprises a cyclic structure; (ii) a colored polymeric resin layer comprising a colorant, wherein the colored polymeric resin layer is 50-250 micrometers thick; and (c) an adhesive layer, wherein the adhesive layer comprises a pressure sensitive adhesive or a hotmelt adhesive. In one embodiment, the multilayered paint films may be used to cover parts for automotive and aerospace applications.

### TECHNICAL FIELD

A multilayered paint film is disclosed for paint applications. The provided films can be useful, for example, in a variety of applications including automotive and aerospace interiors and/or exteriors.

### SUMMARY

There is a desire to identify paint films that have good fidelity when thermoformed onto shaped substrates, wherein the paint films provide good environmental weathering, are stable under chemical and/or heat exposure, and/or resist abrasion.

In one aspect, a multilayered paint film is disclosed. The multilayered paint film comprises in order: (i) a hard coat layer comprising a thermoplastic polyurethane having a hard segment content of 80 percent by weight or greater, wherein the thermoplastic polyurethane is a reaction product of: (a) a diisocyanate; (b) a polyol optionally comprising a cyclic structure; and (c) a chain extender, wherein at least one of the polyol or the chain extender comprises at least one side chain and at least one of the diisocyanate or the chain extender comprises a cyclic structure; (ii) a colored polymeric resin layer comprising a colorant, wherein the colored polymeric resin layer is 50-250 micrometers thick; and (c) an adhesive layer, wherein the adhesive layer comprises a pressure sensitive adhesive or a hotmelt adhesive.

In one embodiment, the multilayered paint film disclosed above is thermoformed onto a metal, a plastic, or a composite substrate.

The above summary is not intended to describe each embodiment. The details of one or more embodiments of the invention are also set forth in the description below. Other features, objects, and advantages will be apparent from the description and from the claims.

### BREIF DESCRIPTION OF THE BRAWINGS

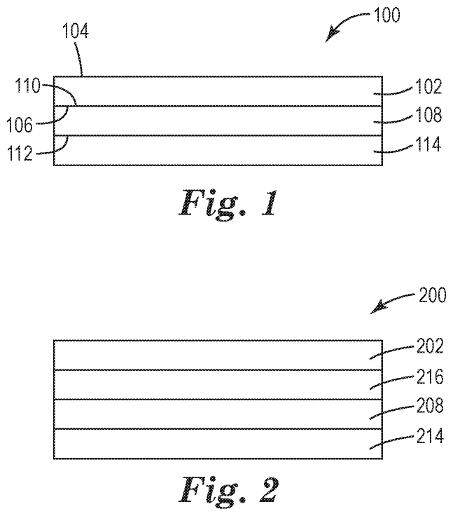

FIG. 1 is a cross sectional elevational view of a multilayered film according to one embodiment of the present disclosure; and

FIG. 2 is a cross sectional elevational view of a multilayered film according to one embodiment of the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“ambient conditions” means at a temperature of 25 degrees Celsius and a pressure of 1 atmosphere (approximately 100 kilopascals);
“backbone” refers to the main continuous chain of the polymer;
“catalyst” means a substance that can increase the speed of a chemical reaction;
“crosslinking” refers to connecting two pre-formed polymer chains using chemical bonds or chemical groups;
“diol” means a compound having a hydroxyl functionality of exactly two;
“diisocyanate” means a compound having an isocyanate functionality of exactly two;
“film” encompasses articles referred to as “sheets”;
“harden” means to alter the physical state and or chemical state of the composition to make it transform from a fluid to less fluid state, to go from a tacky to a non-tacky state, to go from a soluble to insoluble state, to decrease the amount of polymerizable material by its consumption in a chemical reaction, or go from a material with a specific molecular weight to a higher molecular weight;
“hardenable” means capable of being hardened;
“(meth)acrylic” refers to acrylic or methacrylic, and the term “(meth)acrylate” refers to acrylate or methacrylate;
“polyisocyanate” means a compound having an isocyanate functionality of two or more;
“polyol” means a compound having a hydroxyl functionality of two or more;
“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer;
“short-chain diol” means a diol having a weight average molecular weight of at most 185 grams per mole (g/mol); and
“side chain”, relative to a “backbone” or “main chain” is a group of two or more atoms that branch off from the straight chain of carbon atoms formed by polymerization.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

The present disclosure is directed toward a colored film that can be used in place of traditional painting techniques, such as powder coating, spray coating, brushing, etc., to provide colored substrates. The paint films of the present disclosure are multilayered, comprising a hard coat, which provides protection to the underlaying layers, a colored polymeric resin layer, which provides the color, and an adhesive layer, which fixedly attaches the paint film to a desired substrate.

### Film Constructions

A multilayered film according to one exemplary embodiment is illustrated as a schematic in FIG. 1 and designated by the numeral 100. The multilayered film 100 includes a hard coat layer 102 having a first major surface (e.g., top surface) 104 and an opposing second major surface (e.g., bottom surface) 106. The multilayered film 100 further includes a colored polymeric resin layer 108 disposed on the hard coat layer 102, extending across the second major surface 106 of the hard coat layer 102. Optionally and as shown, the colored polymeric resin layer 108 and hard coat layer 102 are laminated to each other such that the layers 102, 108 directly contact each other along essentially the entire second surface 106. If desired, the colored polymeric resin layer 108 may contact the hard coat layer 102 along only a portion of the second surface 106. The colored polymeric resin layer 108 has a first major surface (e.g., a top surface) 110 and an opposing second major surface (e.g., a bottom surface) 112. Adhesive layer 114 contacts and extends along the second major surface 112 of the colored polymeric resin layer 108.

FIG. 2 shows a schematic of a multilayered film 200 according to still another embodiment in which hard coat layer 202 is attached to primer layer 216, which is in turn attached to colored polymeric resin layer 208, which is in turn disposed on adhesive layer 214. Accordingly, primer layer 216 is disposed between hard coat layer 202 and colored polymeric resin layer 208.

One or more additional layers may be coated or laminated to either major surface of the multilayered film. Alternatively, one or more intermediate layers may be interposed between any two adjacent layers present in the multilayered film. Such layer or layers may be similar to those described above or may be structurally or chemically distinct. Distinct layers could include, for example, extruded sheets of a different polymer, a second colored polymeric resin layer, metal vapor coatings, printed graphics, particles, and primers, and may be continuous or discontinuous. For example, in FIG. 1, a tie layer may be disposed between the colored polymeric resin layer 208 and the adhesive layer 114 to improve the quality of adhesion between the two layers.

If desired, the multilayered film (100, 200) could be laminated onto a substrate of interest with adhesive layer (114, 214) contacting the substrate to provide a colored article. In some embodiments, the substrate is a polymeric substrate having three-dimensional contours. Useful substrates may include, for example, injection molded substrates having a 3-dimensional shape such as an interior component in an automotive vehicle.

Although not illustrated in the above figures, multilayered films having exposed adhesive layer surfaces (for example, adhesive layers 114, 214) may further include a release liner extending across and contacting the adhesive layer surfaces. The release liner is releasably bonded on at least a portion of the adhesive layer such that the adhesive layer is interposed between the colored polymeric layer and the release liner. This configuration protects the adhesive layer and facilitates handling of the multilayered film.

One or more additional layers could be permanently or temporarily disposed on the outward-facing surface of the hard coat layer (102, 202). For instance, the hard coat layer may itself comprise multiple hard coat layers. In one embodiment, hard coat layer 102, 202, is substantially free (i.e., less than 2, 1, 0.5, 0.1, or even 0.01% by weight) of a dye or pigment.

Further details concerning the chemical composition of the aforementioned hard coat layers, colored polymeric layer, adhesive layer, primer layers, tie layers, and other supplemental layers are described below.

### Hard Coat Compositions

Typically, the hard coat composition is located on the exposed outer surface of the multilayered paint film and protects the underlaying materials from damage due to environmental weathering, chemical exposure, heat exposure, and/or abrasion. In the present disclosure, the hard coat layer is polyurethane-based. Typically, polyurethanes are synthesized by polymerizing at least one polyisocyanate and at least one polyol. More particularly, in a first aspect of the present disclosure, the hard coat composition comprises a thermoplastic polyurethane having a hard segment content of 80 percent by weight or greater, wherein the thermoplastic polyurethane is a reaction product of:
a) a diisocyanate;
b) a polyol optionally comprising a cyclic structure; and
c) a chain extender, wherein at least one of the polyol or the chain extender comprises at least one side chain and at least one of the diisocyanate or the chain extender comprises a cyclic structure.

Polyols used in polyurethane synthesis include, for example, polyester polyols, polyether polyols, polycaprolactone polyols, polycarbonate polyols, polyolefin polyols, fatty acid dimer diols, and copolymers and mixtures thereof. Examples of suitable polyols include materials commercially available under the trade designation DESMOPHEN from Covestro LLC (Pittsburgh, PA). The polyols can be polyester polyols (for example, DESMOPHEN C1100, C1200, 850, and 1700 or available under the trade designation FOMREZ from Lanxess AG (Cologne, Germany)) or SREPANPOL from Stepan Company (Northfield, IL); polyether polyols (for example, DESMOPHEN 1262BD, 1110BD, 1111BD or materials commercially available under the trade designation KURARAY P-500, P-1010, P-2010, P-3010, P-4010, P-5010, P-6010, P-2011, P-520, P-1020, P-2020, P-1012, P-2012, P-530, P-2030, and P-2050 from Kuraray (Tokyo, Japan)); polycaprolactone polyols such as, for example, caprolactone polyols available under the trade designation CAPA from Ingevity (North Charleston, SC) (for example, CAPA 2043, 2054, 2100, 2121, 2200, 2201, 2200A, 2200D, 2100A, 3031, 3091, and 3051); polycarbonate polyols (for example, polycarbonate polyols available under the trade designations PC-1122, PC-1167, and PC-1733 from Picassian Polymers (Boston, MA), under the trade designation DESMOPHEN C2102, 2202, C XP 2716, C XP 2613 from Covestro LLC, and under the trade designation KURARAY C-590, C-1090, C-2090, and C-3090 from Kuraray); polyolefin polyols (for example polyolefin polyols available from Nippon Soda Co., LTD under the trade designation NISSO-PB); fatty acid dimer diols (for example fatty acid dimer diols (e.g., dimer acids) under the trade designation PRIPOL or PRIPLAST available from Croda Inc (Newark, New Jersey).

In some embodiments, the polyol has a number average (Mn) molecular weight of at least 500, 550, 600, 650, 700, 750, 800, 850, 900, 950, or even 1,000 grams per mole (g/mol); and a Mw less than 2000, 1900, 1800, 1700, 1600, 1500, 1400, 1300, 1200, or even 1,100 g/mol or less.

In some embodiments, the polyol has a structure of the following Formula (I):

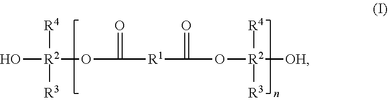

Wherein R¹ and R² are independently selected from a (C₁-C₄₀)alkylene, (C₂-C₄₀)alkenylene, (C₄-C₂₀) arylene, (C₁-C₄₀) acylene, (C₄-C₂₀) cycloalkylene, or (C₄-C₂₀) aralkylene, or (C₁-C₄₀)alkoxyene, which may be substituted or unsubstituted; and R³ and R⁴ are independently selected from —H, —OH, (C₁-C₄₀)alkyl, (C₂-C₄₀)alkenyl, (C₄-C₂₀) aryl, (C₁-C₂₀) acyl, (C₄-C₂₀) cycloalkyl, (C₄-C₂₀) aralkyl, and (C₁-C₄₀)alkoxy, which may be substituted or unsubstituted, and is a positive integer greater than or equal to 1 (for example, greater than 2, 4, 5, or even greater than 10). Suitable substituent groups for any of R¹ through R⁴ include, for instance, alkyl, cyclohexyl, benzyl, aryl, alkoxy, and/or aryloxy.

Specific examples of suitable carboxylic acids according to Formula (I) include glycolic acid (2-hydroxyethanoic acid), lactic acid (2-hydroxypropanoic acid), succinic acid (butanedioic acid), 3-hydoxybutanoic acid, 3-hydroxypentanoic acid, terepthalic acid (benzene-1,4-dicarboxylic acid), naphthalene dicarboxylic acid, 4-hydroxybenzoic acid, 6-hydroxynaphtalane-2-carboxylic acid, oxalic acid, malonic acid (propanedioic acid), adipic acid (hexanedioic acid), pimelic acid (heptanedioic acid), ethanoic acid, suberic acid (octanedioic acid), azelaic acid (nonanedioic acid), sebacic acid (decanedioic acid), glutaric acid (pentanedioic acid), dedecandioic acid, brassylic acid, thapsic acid, maleic acid ((2Z)-but-2-enedioic acid), fumaric acid ((2E)-but-2-enedioic acid), glutaconic acid (pent-2-enedioic acid), 2-decenedioic acid, traumatic acid ((2E)-dodec-2-enedioic acid), muconic acid ((2E,4E)-hexa-2,4-dienedioic acid), glutinic acid, citraconic acid ((2Z)-2-methylbut-2-enedioic acid), mesaconic acid ((2E)-2-methyl-2-butenedioic acid), itaconic acid (2-methylidenebutanedioic acid), malic acid (2-hydroxybutanedioic acid), aspartic acid (2-aminobutanedioic acid), glutamic acid (2-aminopentanedioic acid), tartonic acid, tartaric acid (2,3-dihydroxybutanedioic acid), diaminopimelic acid ((2R,6S)-2,6-diaminoheptanedioic acid), saccharic acid ((2S,3S,4S,5R)-2,3,4,5-tetrahydroxyhexanedioic acid), mexooxalic acid, oxaloacetic acid (oxobutanedioic acid), acetonedicarboxylic acid (3-oxopentanedioic acid), arbinaric acid, phthalic acid (benzene-1,2-dicarboxylic acid), isophtalic acid, diphenic acid, 2,6-naphtalenedicarboxylic acid, dimer fatty acid, or a mixture thereof. Preferred acids are terepthalic acid (benzene-1,4-dicarboxylic acid), naphthalene dicarboxylic acid, adipic acid (hexanedioic acid), pimelic acid (heptanedioic acid), suberic acid (octanedioic acid), azelaic acid (nonanedioic acid), sebacic acid (decanedioic acid), dedecandioic acid, phthalic acid (benzene-1,2-dicarboxylic acid), isophtalic acid, dimer fatty acid, or a mixture thereof. The most preferred acids are terepthalic acid (benzene-1,4-dicarboxylic acid), adipic acid (hexanedioic acid), phthalic acid (benzene-1,2-dicarboxylic acid), isophtalic acid, dimer fatty acid, or a mixture thereof.

It has been discovered that the presence of a side chain in the structure of at least one of the polyol or the chain extender advantageously reduces crystallization of the resulting polyurethane, which tends to decrease brittleness of the polyurethane without also decreasing the hardness of the polyurethane. In some embodiments, the polyol comprises a side chain. In some embodiment, the chain extender comprises a side chain. Optionally, both the polyol and the chain extender can have a side chain in their structures. In select embodiments, the polyol includes at least one ring in its structure, i.e., comprises a cyclic structure.

Examples of diisocyanates include: aromatic diisocyanates (for example, 2,6-toluene diisocyanate; 2,5-toluene diisocyanate; 2,4-toluene diisocyanate; m-phenylene diisocyanate; p-phenylene diisocyanate; methylene bis(o-chlorophenyl diisocyanate); methylenediphenylene-4,4′-diisocyanate; polycarbodiimide-modified methylenediphenylene diisocyanate; (4,4′-diisocyanato-3,3′,5,5′-tetraethyl)diphenylmethane; 4,4′-diisocyanato-3,3′-dimethoxybiphenyl(o-dianisidine diisocyanate); 5-chloro-2,4-toluene diisocyanate; and 1-chloromethyl-2,4-diisocyanato benzene), aromatic-aliphatic diisocyanates (for example, m-xylylene diisocyanate and tetramethyl-m-xylylene diisocyanate); aliphatic diisocyanates (for example, 1,4-diisocyanatobutane; 1,6-diisocyanatohexane; 2-methyl-1,5-pentamethylene diisocyanate; 1,12-dodecane diisocyanate); cycloaliphatic diisocyanates (for example, methylenedicyclohexylene-4,4′-diisocyanate; 3-isocyanatomethyl-3,5,5-trimethylcyclohexyl isocyanate (isophorone diisocyanate); 2,2,4-trimethylhexyl diisocyanate; 1,4-cyclohexanebis(methylene isocyanate), 1,3-bis(isocyanatomethyl)cyclohexane; and cyclohexylene-1,4-diisocyanate), polymeric or oligomeric compounds (for example, polyoxyalkylene, polyester, polybutadienyl, and the like) terminated by two isocyanate functional groups (for example, the diurethane of toluene-2,4-diisocyanate-terminated polypropylene oxide glycol); polyisocyanates commercially available under the trade designation MONDUR or DESMODUR (for example, DESMODUR XP7100 and DESMODUR 3300) from Covestro LLC (Pittsburgh, PA); and combinations thereof.

Of these, particularly advantageous diisocyanates include aliphatic diisocyanates. Aliphatic diisocyanates were generally observed to provide superior weatherability compared with their aromatic counterparts. Particularly preferred species include dicyclohexylmethane diisocyanate, isophorone diisocyanate, hexamethylene diisocyanate, trimethylhexamethylene diisocyanate, tetramethylxylene diisocyanate (TMXDI), 1,4-cyclohexanebis(methylene isocyanate), 1,3-bis(isocyanatomethyl)cyclohexane, 2-methyl-1,5-pentamethylene diisocyanate, 1,12-dodecane diisocyanate, along with copolymers and mixtures thereof. In select embodiments, the diisocyanate includes at least one ring in its structure, i.e., comprises a cyclic structure.

In some embodiments, the chain extender has a weight average molecular weight of at most 400, 300, or even 200 g/mol. When the chain extender has a weight average molecular weight of at most 185 g/mol and two hydroxyl groups, it is considered a short-chain diol. The size of the chain extender is generally more important than the chemical structure. Without wishing to be bound by theory, it is believed that the relatively small size of the chain extender assists in forming an amorphous structure by helping to minimize or prevent the production of any crystalline structure of a resulting polyurethane. Suitable chain extenders include for instance and without limitation, a diol, a polyester diol, a poly(oxy)alkylenediol with an oxyalkylene group having 2 to 4 carbon atoms, or any combination thereof. Representative examples of suitable chain extenders include 3-methyl-1,5-pentanediol, 1,4-butanediol, ethylene glycol, diethylene glycol, dipropylene glycol, neopentyl glycol, 1,6-hexanediol, 1,4-cyclohexane dimethanol, bis(2-hydroxylethyl) hydroquinone (HQEE), and combinations thereof. 3-Methyl-1,5-pentanediol (MPD), for instance, is commercially available from Tokyo Chemical Industry Co., Ltd. (Tokyo, Japan); 1,4-butanediol is commercially available from BASF (Ludwigshafen, Germany); and 1,4-cyclohexane dimethanol and 1,6-hexanediol are each commercially available from Sigma Aldrich (St. Louis, MO). In select embodiments, the chain extender includes at least one ring in its structure, i.e., comprises a cyclic structure.

In preferred embodiments, the thermoplastic polyurethane is substantially non-crosslinked. In these cases, the above diisocyanates and polyols are generally diisocyanates and diols, respectively, where each of these components has a functionality of two. Such functionalities produce long linear polymeric chains that allow the polyurethane material to be reprocessed at elevated temperatures. Notwithstanding, small degrees of crosslinking may be acceptable in some instances.

The linear polymeric chains of a thermoplastic polyurethane generally contain long, low-polarity “soft segments” and shorter, high-polarity “hard segments.” In some embodiments, the soft and hard segments are synthesized in a one-step reaction that includes an isocyanate, short-chain diol, and long-chain diol. Upon conversion, the isocyanate and short-chain diol collectively form the hard segment, while the long-chain diol alone forms the soft segment. At ambient conditions, the hard segments form crystalline or pseudo-crystalline regions in the microstructure of the polyurethane, accounting for its elasticity. The soft segments provide a continuous matrix that enables facile elongation of the polyurethane material. The soft segment portion may or may not be the majority phase of the polyurethane composition.

The long-chain diol has a weight average molecular weight significantly greater than that of the short-chain diol. In some embodiments, for example, the long-chain diol has a weight average molecular weight of at least 500, 600, 700, 800, 900, or even 950 g/mol; and at most 5000, 4000, 3000, 2000, 1500 or even 1000 g/mol.

In some embodiments, the thermoplastic polyurethane has a hard segment content of at least 80, 81, 82, 83, 84, 85, 86, 87, 88, 89, or even 90 percent by weight, relative to the overall weight of the thermoplastic polyurethane. In some embodiments, the thermoplastic polyurethane has a hard segment content of at most 98, 97, 96, 95, 94, 93, 92, 91, 90, 89, 88, 87, 86, 85, 84, 83, or even 82 percent, relative to the overall weight of the thermoplastic polyurethane.

The hard segment content can be calculated from the relative weights of the starting materials used in preparing the polyurethane. In the embodiments described herein, the hard segment content is determined using the following formula:

$$Hard segment wt . \% = 100 \% \times [ wt . of ( short - chain diol + diisocyanate ) ] / [ wt . of ( polyol + diisocyanate + additives ) ]$$

Additives, for instance, can include catalysts and ultraviolet light-related components (e.g., stabilizers, absorbers, etc.). While the relative amounts of long-chain and short-chain diols can vary over a wide range depending on the hardness desired, the overall relative amounts of polyisocyanate to polyol (which includes all diols) are generally selected to be stoichiometric equivalent amounts. In some instances, it may be desired to use an excess of one component, such as polyol, to minimize unreacted remnant of the other component.

It has been unexpectedly discovered that polyurethane hard coat compositions with a hard segment content of 80 wt. % or greater and formed from polyol and/or chain extender structures including at least one side chain, provides improved chemical resistance as compared to polyurethane hard coat compositions with a hard segment content less than 80 wt. % and/or without a side chain in the reactant(s).

The kinetics of the polymerization between the polyisocyanate and polyol species is typically accelerated with the help of a suitable catalyst. In exemplary embodiments, the hard coat composition is prepared using any of a wide variety of known urethane catalysts, including dibutyltin dilaurate, dibutyltin diacetate, stannous octoate, triethylene diamine, zirconium catalysts, and bismuth catalysts.

Other additives can be added in order to enhance the performance of the hard coat compositions. For example, ultraviolet light-related components may include one or more of ultraviolet light (UV) absorbers, radical scavengers, antioxidants, and the like. Such additives and the use thereof are well known in the art. It is understood that any of these compounds can be used so long as they do not deleteriously affect the properties of the hard coat composition. Typical amounts of additives include an amount of about 0.1-5% by weight, about 0.5-4% by weight, or about 1-3% by weight, based on the total weight of the hard coat composition.

Some representative examples of suitable UV absorbers include 5-trifluoromethyl-2-(2-hydroxy-3-alpha-cumyl-5-tert-octylphenyl)-2H-benzo-triazole, 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, 2 (-4,6-diphenyl-1-3,5-triazin-2-yl)-5-hexcyloxy-phenol, and combinations thereof. Some representative examples of suitable radical scavengers include a hindered amine light stabilizer (HALS) compound and/or a hydroxyl amine. One representative suitable antioxidant includes a hindered phenol.

The overall molecular weight of the polyurethane after polymerization should be sufficiently high to provide high strength and elongation properties for thermally processing the composition (such as thermoforming or thermal lamination applications), yet not so high that melt processing of the polymer is unduly complicated. In exemplary embodiments, the aliphatic thermoplastic polyurethane can have a weight average molecular weight of at least 100000, 150000, 200000, 250000, 300000, 350000, or even 400,000 g/mol. In exemplary embodiments, the aliphatic thermoplastic polyurethane can have a weight average molecular weight of at most 800000, 750000, 700000, 650000, or even 600,000 g/mol.

In some embodiments, the thermoplastic polyurethane has a substantially monomodal molecular weight distribution. Such a distribution can be achieved, for example, using the methods disclosed in U.S. Pat. No. 8,128,779 (Ho, et al.). The polydispersity index of the polyurethane, defined as the ratio between the weight average molecular weight and number average molecular weight, can be at least 1.1,1.5, 2.0, 2.5, or even 3.0. As to the same or alternative embodiments, the polydispersity index of the polyurethane can be at most 6.0, 5.7, 5.5, 5.2, or even 5.0.

It is desirable for the disclosed hard coat compositions to display a hardness that is sufficient to avoid or substantially reduce the degradation of its surface finish when subjected to harsh environmental conditions over extended periods of time. For example, for exterior automotive paint applications, the hard coat composition should be hard enough to resist scratching from stones, sand, road debris, and bugs during the expected lifetime of the paint film. In exemplary embodiments, the hard coat composition has a Shore D hardness of at least 70, 71, 72, 73, 74, 75, 76, 77, 78, 79, 80, 81, 82, 83, 84, 85, 86, 87, 88, 89, 90, 91, 92, 93, 94, or even 95.

In some embodiment, the hard coat compositions exhibit a glass transition temperature (T_{g}) of 70, 80, 90, 100, 110, 115, or even 118° C. or greater; and less than 200, 175, 150, 130, 125, or even 120° C. as measured by dynamic mechanical analysis as described in the Example Section.

In one embodiment, the hard coat layer has a thickness that ranges from 5 micrometers to 300 micrometers. However, the hard coat layer can be provided in any suitable thickness based on the application at hand. For example, a typical overall film thickness for paint films formed over automotive body panels is at least 75 micrometers, or even 100 micrometers. In the same or alternative embodiments, film thickness is at most 1.5, 1.3, 1.1, or even 1.0 millimeters (mm).

The hard coat is typically the outward facing portion of the multilayered article and provides protection for the underlying layers and substrate against weathering, abrasion, and/or chemical exposure. Thus, the hard coat layer must be durable, but also be able to thermoform (i.e., the action of changing shape with the aide of heat and usually pressure) around objects. The performance properties disclosed herein for the hard coat layer, would also be applicable to the overall multilayered paint film as well. The hard coat should have sufficient mechanical properties enabling the hard coat layer to be stretched over substrates having complex curvatures in three dimensions. Because of the variety of different substrates that could be encountered, it is desirable for the hard coat composition to be capable of being stretched uniformly over a substantial distance without breaking. At room temperature (for example, 23° C.), the hard coat composition optionally has an Elongation at Break test result (whose specifics shall be defined in the forthcoming Examples) of at least 5, 6, 7, 8, 10, 12, 14, 16, or even 18 percent.

The ability of the provided hard coat compositions to elongate without breakage can be substantially enhanced at high temperatures. Further, the degree of enhancement was unexpected. When processed at thermoforming temperatures, for example, films of the provided hard coat composition were observed to be stretched to a far greater extent than that of conventional hard coat films. At 100° C., for example, the provided hard coat compositions can have an elongation at break test result of at least 140, 145, 150, 160, 170, 180, 190, 200, 210, or even 220%. At 140° C., for example, the hard coat composition has an elongation at break test result of at least 200, 300, 400, 500, 600, 700, 800, 850, 900, or even 900 percent; and at most 1750, 1500, or even 1000%.

In dynamic mechanical analysis, tan (or the ratio between the storage and loss moduli, E″/E′) is a measure of the amount of deformational energy that is dissipated as heat per cycle at a glass transition temperature of a given polymer. In some embodiments, the provided hard coat compositions display a tan peak of at least 0.7, 0.75, 0.8, 0.85, or even 0.9. In the same or alternative embodiments, the provided hard coat compositions display a tan peak of at most 2.0, 1.75, 1.5, 1.45, 1.4, 1.35, or even 1.3.

Polyurethanes with the above tan values have performed well in dual vacuum thermoforming applications, while displaying low memory. Memory, which results from polymer molecules being retained in a state of stress after being cooled, can be undesirable in thermoforming applications if it stresses the bond between a hard coat and an underlying layer or substrate. The provided hard coat compositions display glassy, elastic behavior at ambient conditions, characterized by comparatively low tan 1. At 25° C., for example, tan can be less than 0.4, 0.35, 0.3, 0.25, 0.20 or even 0.02.

### Colored Polymeric Resin Layer

The colored polymeric resin layer, which is located between the hard coat layer and the adhesive layer, provides the requisite color of the multilayered paint film. This layer comprises a polymer resin, and a colorant.

Examples of colorants include any colorants known in the arts (for example, high performance or automotive grade pigments (whether colored, white, or black), organic pigments, inorganic pigments, pearlescent pigments, carbon black, metal flakes, dyes, and combinations thereof). Exemplary pigments include: titanium dioxide, zinc oxide, lithopone, antimony oxide, zinc sulfide, cadmium yellow, yellow oxides, pyrazolone orange, perinone orange, cadmium red, red iron oxide, alizarin, prussian blue, ultramarine, cobalt blue, chrome green, chromium oxide, phthalocyanine-based pigments, quinacridone-based pigments, and azo-based pigments. In some embodiments, a colorant is selected to have acceptable lightfastness and weathering characteristics for the intended use of the multilayered film of the present disclosure.

The polymeric resin needs to be thermoformable, or has the ability to be shaped without the formation of defects (such as cracks or holes), to at least the same extent or better than the hard coat layer. For example, having an elongation at break test result the same or better than the hard coat layer. The polymeric resin may be a thermoplastic polymer or a thermoset polymer. Examples of polymeric binders include acrylics, urethanes, silicones, polyethers, phenolics, aminoplasts, and combinations thereof.

The amount of colorant (for example, pigment) used in the colored polymeric resin layer is determined by the pigment's intensity and tinctorial strength, the required opacity, the thickness of the colored polymeric resin layer, the amount of deformation of the colored polymeric resin layer, the required gloss, and/or the resistance and durability desired. In one embodiment, the colored polymeric resin layer comprises at least 2, 4, 6, 8, 10, or even 15% by weight colorant. Generally, less than 50, 40, 30, 25 or even 20% by weight of colorant is used. In some embodiments, the multilayered paint films of the present disclosure comprise two different colored polymeric resin layers.

The colored polymeric resin layer can be provided in any suitable thickness based on the application at hand. Typically, the colored polymeric resin layer has a thickness that ranges from at least 50, 75, 100, or even 125 micrometers; and at most 300, 250, 200, 175, or even 150 micrometers.

### Adhesive Layer

In an exemplary embodiment, the adhesive layer is a pressure sensitive adhesive that is normally tacky at ambient conditions or is a hot melt adhesive.

Suitable pressure sensitive adhesives can be based on polyacrylates, synthetic and natural rubbers, vinyl acetate, polyurethane, polybutadiene and copolymers or polyisoprenes and copolymers. Silicone based adhesives such as polydimethylsiloxane and polymethylphenylsiloxane may also be used. Particularly preferred pressure sensitive adhesives include polyacrylate-based adhesives, which can display advantageous properties as high degrees of clarity, UV-stability and aging resistance. Polyacrylate adhesives that are suitable for protective film applications are described, for example, in U.S. Pat. No. 4,418,120 (Kealy et al.); RE24,906 (Ulrich); U.S. Pat. No. 4,619,867 (Charbonneau et al.); 4,835,217 (Haskett et al.); and International Publication No. WO 87/00189 (Bonk et al.).

Preferably, the polyacrylate pressure sensitive adhesive comprises a crosslinkable copolymer of a C₄-C₁₂ alkylacrylate and an acrylic acid. The adhesive can be used with or without a crosslinker. Useful crosslinking reactions include chemical crosslinking and ionic crosslinking. The chemical crosslinker could include polyaziridine and/or bisamide and the ionic crosslinker may include metal ions of aluminum, zinc, zirconium, or a mixture thereof. A mixture of chemical crosslinker and ionic crosslinker can also be used. In some embodiments, the polyacrylate pressure sensitive adhesive includes a tackifier such as rosin ester. Adhesives useful in the invention may also contain additives such as ground glass, titanium dioxide, silica, glass beads, waxes, tackifiers, low molecular weight thermoplastics, oligomeric species, plasticizers, pigments, metallic flakes and metallic powders as long as they are provided in an amount that does not unduly degrade the quality of the adhesive bond to the surface.

In one embodiment, the pressure-sensitive adhesive layer has a storage elastic modulus from 0.35 MPa to 10 MPa at ambient conditions (e.g., 23° C.).

As an alternative to pressure sensitive adhesives, the adhesive layer may include a hot melt adhesive, which is not tacky at room temperature, but becomes tacky upon heating. Such adhesives include (meth)acrylics, ethylene vinyl acetate, silicone, and polyurethane materials.

### Primer Layer

In one embodiment, the colored polymeric resin layer is in intimate contact with the hard coat layer. In another embodiment, a primer layer is disposed between the colored polymeric resin layer and the hard coat layer.

In general, for enhanced durability for outdoor usage, a primer layer is formed from a primer composition. Because of its placement in the multilayered paint film of the present disclosure, it is preferable that the primer layer is clear and colorless, preferably aliphatic, being substantially free of aromatic ingredients. Further, polyurethane and/or acrylic based primer compositions are preferred. Primer compositions for forming a primer layer include water-based primer compositions, solvent-based primer compositions, and 100% solids compositions (e.g., extrudable compositions). Upon evaporation of the solvent (e.g., water and/or organic solvent) and/or upon radiation curing, the primer composition forms a continuous layer. The water-based and solvent-based primer compositions comprise one or more film-forming resins. Various film-forming resins are known. Representative film-forming resins include acrylic resin(s), polyvinyl resins, polyester, polyacrylates, polyurethane and mixtures thereof.

The film forming resin of a solvent-based primer composition is admixed with a solvent. The solvent may be a single substance or a blend of solvents. The primer composition preferably contains about 5 to about 80 parts by weight of the resin, more preferably about 10 to about 50 parts resin and most preferably about 15 to about 30 parts resin, based on the entire primer composition.

The solvent may be a single substance or a blend of solvents. Suitable solvents include water, alcohols such as isopropyl alcohol (IPA) or ethanol; ketones such as methyl ethyl ketone, methyl isobutyl ketone (MIBK), diisobutyl ketone (DEBK); cyclohexanone, or acetone; aromatic hydrocarbons such as toluene; isophorone; butyrolactone; N-methylpyrrolidone; tetrahydrofuran; esters such as lactates, acetates, including propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate); iso-alkyl esters such as isohexyl acetate, isoheptyl acetate, isooctyl acetate, isononyl acetate, isodecyl acetate, isododecyl acetate, isotridecyl acetate or other iso-alkyl esters; combinations of these, and the like.

Preferred solvent-based and water-based primer compositions comprise at least about 25 percent by weight of the dry resin of an acrylic resin, and preferably at least about 50 percent by weight. Other preferred solvent-based and water-based primer compositions comprise at least about 10 percent by weight of the dry resin of a polyurethane, and preferably at least about 25 percent by weight. An exemplary solvent-based primer is commercially available from 3M under the trade designation “8801 Toner for Scotchlite Process Color Series Inks”. Further, exemplary compositions for use as water-based primers include sulpho poly(ester urethane) compositions, such as described in U.S. Pat. No. 5,929,160 (Krepski et al.).

### Tie Layer

In one embodiment, the colored polymeric resin layer is in intimate contact with the adhesive layer. In another embodiment, a tie layer is disposed between the colored polymeric resin layer and the adhesive layer to enable good interlayer adhesion therebetween.

The tie layer may be organic (e.g., a polymeric layer) or inorganic. Exemplary inorganic tie layers include metal oxides such as e.g., titanium dioxide, aluminum oxide, or combinations thereof. Exemplary polymeric tie layer materials include phenoxy, or polyurethane resins. The tie layer may be provided by any suitable means, including solvent casting and powder coating techniques.

### Release Liner

In some embodiments, the multilayered paint film of the present disclosure comprises a release liner. A release liner is a temporary support that is not intended for final use of the adhesive article and is used during the manufacture or storage to support and/or protect the multilayered paint film. A release liner is removed from the multilayered paint film prior to final use. The release liner comprises (i) a web, such as paper, a polyester (such as polyethylene terephthalate), an olefin (such as high density polyethylene); and (ii) in some instances, a release coating. The release coating can be used to facilitate easy removal from the adhesive layer, especially, a pressure sensitive adhesive layer. The release coating comprising a release agent, Release agents are known in the art and are described, for example in “Handbook of Pressure Sensitive Adhesive Technology,” D. Satas, editor, Van Nostrand Reinhold, New York, N.Y., 1989, pp. 585-600. In one embodiment, the release agent migrates to the surface (on the liner or release coating) to provide the appropriate release properties. Examples of release agents include carbamates, silicones and fluorocarbons. Illustrative examples of surface applied (i.e., topical) release agents include polyvinyl carbamates such as disclosed in U.S. Pat. No. 2,532,011 (Dahlquist et al.), reactive silicones, fluorochemical polymers, epoxysilicones such as disclosed in U.S. Pat. No. 4,313,988 (Bany et al.) and 4,482,687 (Kessel et al.), polyorganosiloxane-polyurea block copolymers, etc.

### Methods of Making

The manufacture of the multilayered films shown in FIGS. 1-2 involves forming three or more layers, as described, that are coupled to each other. The layers constituting the multilayered films may be prepared in parallel or in series.

In one embodiment, the multilayered paint film is substantially free of solvent.

The hard coat layer in particular may be formed using conventional techniques known to those of ordinary skill in the art. Such techniques include, for example, coating, or extruding onto a substrate. One skilled in the art can coat or extrude the disclosed hardenable compositions onto a substrate using either batch or continuous techniques.

In a preferred method, a hard coat layer is formed by extruding it at an elevated temperature through an extrusion die. The hard coat layer may also be formed by casting or otherwise molding (for example, injection molding) the composition into the shape desired.

If desired, the hard coat layer and one or more intermediate layers may be coupled by laminating the layers to each other at elevated temperature and pressure. For example, one major surface of the hard coat layer may be cold laminated under pressure to one major surface of the colored polymeric layer, while at least the one major surface of the hard coat layer is, or both the hard coat layer and the colored polymeric layer are at an elevated temperature that is sufficiently high to facilitate adequate bonding between the two layers. In a “cold laminating” process, the layers are laminated together between two nip surfaces near an ambient temperature environment (that is, the layers are not kept in an intentionally heated environment during the laminating process).

Advantageously, the use of chilled surfaces may eliminate, or at least help reduce, warping of the layers resulting from the laminating process. At the same time, the major surfaces that make contact at the interface between the layers remain at the elevated temperature long enough to be sufficiently bonded together by the laminating pressure exerted by the nip surfaces. Cold laminating may be accomplished by laminating a newly extruded hard coat layer directly onto a preformed colored polymeric, while the hard coat composition retains significant heat from the extrusion process. Optionally, the colored polymeric resin layer is releasably bonded to a carrier web or release liner to provide additional structural strength.

Alternatively, the hard coat layer may be bonded to a colored polymeric along their respective major surfaces using a hot laminating process. In this process, the initial temperatures of the layers are too low to sustain adequate bonding between them and at least one major surface of either the hard coat layer, colored polymeric, or both is heated and pressure applied to facilitate bonding between the hard coat layer and the colored polymeric. Typically, minimum temperatures and pressures for bonding the layers together using either the cold or hot laminating process, are at least about 93° C. and at least about 10.3 N/cm², respectively.

In another embodiment, the various layers are coextruded together from a die.

In some embodiments, it may be desirable to corona treat (using, for example, air or nitrogen), a major surface of a colored polymeric resin layer prior to bonding the major surface to an adhesive layer and/or a hard coat layer. Such treatment can improve adhesion between these layers.

Further details relating to the fabrication and processing of the hard coat compositions described herein are described in U.S. Pat. No. 8,128,779 (Ho et al.).

### Constructions

The multilayered films of the present disclosure can be used as a paint film to cover unfinished metal, plastic, and composite parts for example, for both interior and exteriors in auto and aerospace applications. Typically, the substrates to be covered are three-dimensional in shape. Advantageously, the multilayered paint films of the present disclosure can be shaped around objects having a high degree of curvature, having good aesthetic appeal (e.g., smooth surface) and having good physical properties (e.g., good weathering, stain resistant, good thermal resistance and/or good chemical resistance).

The multilayered paint films of the present disclosure may have a rectilinear geometry or it may take on any of a number of different configurations. For example, the multilayered film may have three-dimensional contours that include regions of positive and/or negative curvature. Even if the multilayered film is formed as a flat sheet, it can be subsequently die-cut, thermoformed (i.e., use heat and pressure to stretch over a part), thermally laminated (i.e., use heat and optional pressure to apply onto something), embossed (i.e., applying a texture or feature to a surface), or otherwise formed into a shape different from its original shape.

In one embodiment, the multilayered paint films of the present disclosure are applied onto a shaped object and formed around the object. Any technique known in the art can be used to conform the multilayered paint film to the object, including, but not limited to, thermoforming, vacuum/air pressure molding (Dual Vacuum Thermoforming [DVT]) method, a vacuum molding (Vacuum Thermoforming [VT]) method, a hydraulic transfer method, or the like.

Dual vacuum thermoforming, also sometimes referred to as Three-dimension Overlay Method (“TOM”), can be carried out using any suitable instrument known to one of skill in the art. Such instruments include vacuum molding machines manufactured by Fuse Vacuum Forming Company in Japan. Further aspects of dual vacuum thermoforming are described in U.S. Patent Publication No. 2011/10229681 (Sakamoto et al.).

In one embodiment, the multilayer paint films of the present disclosure are applied to a surface using dual vacuum thermoforming. In some embodiments, dual vacuum thermoforming of the multilayered paint film, occurs at a temperature of at least 25, 35, 40, 50, or even 60° C. In some embodiments, the dual vacuum thermoforming of the multilayered paint film occurs at a temperature of at most 180, 170, 165, 160, 150, or even 140° C.

The multilayered paint films of the present disclosure can be any color known to paint including red, orange, yellow, green, blue, violet, indigo, or combinations thereof, also including black and white.

Because the multilayered films of the present disclosure are used to cover unfinished parts, the films should be at least translucent and more preferably, opaque. In one embodiment, the multilayered film of the present disclosure has a transmission of visible light (i.e., 400-750 nm) of at most 50, 40, 30, 20, 10, or even 5%. In some embodiments, the multilayered film of the present disclosure has no detectable transmission of visible light when measured in accordance with JIS K 7375:2008.

Of the transmitted light through the sample, haze refers to the percentage of the light that deviates more than 2.5 degrees from the incident beam. Haze is a measure of the wide angle scattering and results in a reduction in contrast. In one embodiment, the multilayered paint films of the present disclosure have a haze of less than 0.5, 0.4, 0.3, or even 0.2% as measured using the test method disclosed below.

The paint films of the present disclosure can have a matte, eggshell, semi-gloss, and gloss finish. Typically, the glossiness of the multilayered paint film is imparted from the hard coat layer, which may comprise a gloss-imparting agent. In one embodiment, the multilayered paint film of the present disclosure has a gloss at 60 degrees of at least 80, 90, or even 100 gloss units (GU) as measured using the test method disclosed herein. In one embodiment, the multilayered paint film of the present disclosure has a gloss at 20 degrees of at least 75, 80, or even 85 GU as measured using the test method disclosed herein retention after exposure to ultraviolet light. In one embodiment, the multilayered paint film has good gloss retention after weathering such as exposure to ultraviolet light. For example, after exposure to ultraviolet light (3000 hours), the multilayered paint film has a gloss at 60 degrees of at least 85, 90, or even 100 GU.

In one embodiment, the multilayered film of the present disclosure is thermally stable, meaning that when the multilayered paint film is heat aged, there is minimal change in color. For example, when heat aged for 7 days at 80° C., the change in overall color (or ΔE* in the CIELAB color space) is less than 2.0, 1.8, 1.5, 1.2, 1.0, 0.9, 0.8, 0.7, 0.6, 0.5, or even 0.4. For example, when heat aged for 7 days at 95° C., ΔE* is less than 1.6, 1.5, 1.4, 1.3, 1.2, 1.0, 0.9, 0.8, 0.7, 0.6, or even 0.5. For example, when heat aged for 7 days at 105° C., ΔE* is less than 1.6, 1.5, 1.4, 1.3, 1.2, 1.0, 0.9, or even 0.8.

In one embodiment, the multilayered film of the present disclosure is stable to ultraviolet radiation, meaning that when the multilayered paint film is exposed to UV light over a prolonged period of time, there is minimal change in its color. For example, when the multilayered paint film is exposed to 3000 hours of ultraviolet radiation, ΔE is less than 1.8, 1.6, 1.5, 1.2, 1.0, 0.8, 0.6, or even 0.4.

In one embodiment, the multilayered film of the present disclosure resists stain. For example, in one embodiment, the multilayered paint film was exposed to asphalt and then cleaned and the change in color of the surface was measured. In one embodiment, the multilayered film of the present disclosure has a color change (ΔE*) of less than 2, 1.5, 1, 0.8, or even 0.6 when tested as described in the Example Section below. In one embodiment, the multilayered film of the present disclosure has a Ab* change of less than 2.5, 2, 1.5, 1, 0.8, 0.7, or even 0.6.

In one embodiment, the multilayered film of the present disclosure is resistant to chemical attack. For example, when exposed to hydrochloric acid, caustic soda, and/or sulfuric acid there is no evidence of exposure and no change in color as described in the Example Section below.

The multilayered paint film according to the present disclosure can be applied to a variety of objects including automotive and areospace vehicles. Examplary parts include the body (including a roof, a door, a hood, and the like) of a vehicle or a part of the body, or to a constituent part (for example, a bumper, a roof molding, a side guard mold, a pillar, and the like) of a vehicle. Examples of the vehicles include: cars such as trucks, buses, recreational vehicles, and passenger cars; two-wheeled vehicles such as motorcycles and motor scooters; bicycles; trains; and ships such as pleasure boats, yachts, and motorboats.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| 1,4-CHDM | 1,4-Cyclohexanedimethanol, mixture of cis and | Eastman Chemical |
| | trans, 99% | Company, Kingsport |
| | | TN |
| KP-1020 | Polyester polyol (MPD-terephthalate), molecular | Kuraray, Tokyo, |
| | weight = 1000 g/mol; obtained under the trade | Japan |
| | designation “KURARAY POLYOL P-1020” | |
| C2100A | Caprolactone polyol, molecular weight = 1000 | Perstorp AB, Malmo, |
| | g/mol; obtained under the trade designation | Sweden |
| | “CAPA 2100A” | |
| F44-111 | Polyester polyol, molecular weight = 1000 g/mol; | Chemtura, |
| | obtained under the trade designation “FOMREZ | Middlebury, CT |
| | 44-111” | |
| 1,4-BD | 1,4-butanediol Chain extender diol, 99.8% pure | BASF, |
| | | Ludwigshafen, |
| | | Germany |
| F55-112 | Polyneopentyl glycol adipate having a molecular | Chemtura Corp, |
| | weight of 1000 g/mol available under the trade | Middlebury, CT |
| | designation “FOMREZ 55-112” | |
| F55-225 | Polyester polyol having a molecular weight of | Chemtura Corp., |
| | 500 g/mol available under the trade designation | Middlebury, CT |
| | “FOMREZ 55-225” | |
| SPF6 | A polyurethane based virtually clear surface | 3M Company, St. |
| | protection film, 6 mil, available under the trade | Paul, MN |
| | designation “3M Surface Protection Film SPF6” | |
| T292 | Liquid hindered amine obtained under the trade | BASF, Florham park, |
| | designation “TINUVIN 292” | NJ |
| T479 | UV light stabilizer obtained under the trade | BASF, Florham park, |
| | designation “TINUVIN 479” | NJ |
| T405 | Triazine-based UV absorber obtained under the | BASF, Florham park, |
| | trade designation “TINUVIN 405” | NJ |
| DT12 | Dibutyl tin dilaurate catalyst obtained under the | Air Products, |
| | trade designation “DABCO T12 CATALYST” | Allentown, PA |
| DES-W | Liquid cycloaliphatic diisocyanate obtained | Covestro, |
| | under the trade designation “DESMODUR W” | Leverkusen, |
| | | Germany |
| Glycerol | polyol compound used as a crosslinker | Fisher Scientific, |
| | | Pittsburgh, PA |
| E5XM | epoxy-based cross-linking agent available under | Soken Chemical & |
| | the trade designation “E-5XM” | Engineering Co., |
| | | Ltd. |
| | | (Toshima-ku, Tokyo, |
| | | Japan) |
| TMS-18 | Urethane resin available under the trade | Negami Chemical |
| | deignation “ART RESIN TMS-18” | Industrial Co., Ltd., |
| | | Nomi, Ishikawa, |
| | | Japan |
| YP50EK35 | Phenoxy resin available under the trade | Nippon Steel, |
| | deignation “YP50EK35” | Tyokyo, Japan |
| BYK-355 | Leveling agent available under the trade | BYK Chemee |
| | deignation “BYK-355” | Japan, Tyokyo, |
| | | Japan |
| White Paint | White color sol, non-aqueous, | BASF Japan |
| | | (Chuo-ku, Tokyo, |
| | | Japan) |
| Butyl acetate | Butyl acetate | Daicel Corporation |
| | | (Osaka City, Osaka |
| | | Prefecture, Japan) |
| MIBK | Methyl isobutyl ketone | KH Neochem Co., |
| | | Ltd. |
| | | (Chuo-ku, Tokyo, |
| | | Japan) |
| C3031 | Caprolactone polyol, molecular weight = 300 | Perstorp AB, Malmo, |
| | g/mol; obtained under the trade designation | Sweden |
| | “CAPA 3031” | |
| DES-540/3 | Heat activated polyurethane (PU) adhesive | Covestro, |
| | pellets; obtained under the trade designation | Leverkusen, |
| | “Desmomelt 540/3” | Germany |
| F4202 | A catalyst of dibutyltin dilaurate under the trade | PMC |
| | designation “FASCAT 4202”, | Organometallix, Inc., |
| | | Mount Laurel, NJ |
| I1076 | Antioxidant obtained under the trade designation | BASF, Florham park, |
| | “IRGANOX-1076” | NJ |
| S1010 | Antioxidant obtained under the trade designation | Songwon Industrial |
| | “SONGNOX-1076” | Group, Ulsan City, |
| | | South Korea |
| PET liner | Polyethylene terephthalate film | Mitsubishi Chemical |
| | | America, Inc. |
| | | Charlotte, NC |
| D6260 | Water dispersible polycarbonate urethane resin | Dainichiseika Color |
| | available under the trade designation “D6260” | & Chemicals Mfg. |
| | | Co., Ltd., Tokyo, |
| | | Japan |
| D28 | Thickener available under the trade designation | |
| | “D28” | |
| 104E | wetting agent available under the trade | Nissin Chemical |
| | designation “104E” | Industry Co., Ltd., |
| | | Tokyo, Japan |
| Acrylic PSA | An acrylic adhesive transfer tape having a 90:10 | 3M, St. Paul, MN |
| | isooctyl acrylate:acrylic acid ratio | |
| White test panel | White panel coated with a clear coat top layer | ACT test Panels, |
| | available as part 0-1830 | LLC., Hillsdale, MI |
| White pigment | 45-50 wt % TiO2-based masterbatch with an | Clariant, |
| | aliphatic thermoplastic polyurethane carrier | Muttenz, Switzerland |
| PM Acetate | Propylene glycol monomethyl ether acetate | Eastman |
| | slow evaporating solvent available under the | Chemicals, |
| | trade designation “PM Acetate” | Kingsport, TN. |
| | | United States |
| SET 17-1608 | Hydroxy functional acrylic resin available | Allnex, Alpharetta, |
| | under the trade designation “SETALUX 17- | GA. United States |
| | 1608” | |
| SET 57-2500 | Hydroxy functional acrylic resin available | Allnex, Alpharetta, |
| | under the trade designation “SETALUX 57- | GA. United States |
| | 2500” | |
| Xylene | Aromatic hydrocarbon solvent | Azer Scientific, Inc, |
| | | Morgantown, PA. |
| | | United States |
| CAB 381-0.1 | Cellulose acetate butyrate ester with medium | Eastman |
| | butyryl content and low viscosity available | Chemicals, |
| | under the trade designation “CAB 381-0.1” | Kingsport, TN. |
| | | United States |
| DE N3390 | Aliphatic polyisocyanate available under the | Covestro AG, |
| | trade designation “DESMODUR N3390 | Leverkusen, |
| | BA/SN” | Germany |
| TEGO-5001 | Silicone polyacrylate polyol resin available | Evonik Industries |
| | under the trade designation “TEGO Protect | AG, Essen, |
| | 5001” | Germany |

### Test Methods

### Haze and Gloss Mesurements

A calibrated Haze-Gard Plus obtained from BYK Gardner USA (Columbia, MD) was used to test the haze and gloss of the hard coat layer side of the specimen. The % Haze of the hard coat surface was tested for each sample as is. For gloss measurements, each sample was measured and reported at both 60 degrees and 20 degrees and prepared as follows: for PREP-1 to PREP-4 and PREP-7, the hard coat layer was applied onto the White test panel using the acrylate PSA and then measured. For EX-1 and EX-2, the adhesive side of the samples was applied to the White test panel and then measured.

### Tensile Strength and Elongation at Break Test Method

The tensile properties of the hard coat layer were evaluated using the procedures described in ASTM Test Method D 882-02, “Tensile Properties of Thin Plastic Sheeting” using an INSTRON tensile tester (Instron, Norwood, MA). Percent elongation at break was measured at room temperature, 100° C., and 140° C. Young's Modulus was also measured from the initial linear portion of the stress-strain curve. Specimens were 2.54 centimeters (cm) in width, 1.27 cm in length, and about 3 mils (76 micrometers thick). Each specimen was tested at a crosshead speed of 30.5 cm/minute with a 1.27 cm jaw separation. When tested at 100° C. and 140° C., the specimen was placed inside the heat chamber, which was at temperature and equilibrated 1 minute before testing. Typically, three specimen were run for each sample.

### Dynamic Mechanical Thermal Analysis Test Method

The elastic moduli of the hard coat were measured from −50° C. to 150° C. in tension using a solid analyzer (RSA II from Rheometric Scientific Inc, Piscataway, NJ) at 1 Hz (6.28 radians/second). A typical thin strip of sample (6.865 millimeter (mm) width by 22.8 mm length and thickness range from 0.012 mm to 0.022 mm) was mounted in the clamps and tightened. Pre-determined amplitude and frequency was applied to the sample and the stress response of the material was measured. E′, elastic modulus, and E″, loss modulus, were measured. The ratio of E″/E′, also referred to Tan delta, E′, and E″ vs. temperature were obtained. The glass transition temperature (T_{g}) was obtained at the maximum of Tan delta and is reported in Table 3.

### Staining Test Method

EX-1, EX-2, and the White test panel were used as is. For PREP-1 to PREP-5, PREP-8, and CE-1, each of the hard coat layers was applied onto a White test panel of 1 inch×5 inch, using an acrylate PSA to make a specimen for testing. A colorimeter (Color i5 from X-rite, Grand Rapids, MI) was positioned in front of the hard coat side of each sample and the color was measured using the CIELAB color space according to ASTM E1347 (2020) under a 25 mm orifice. A 50% by volume mixture of Marathon Oil AC-20 non-emulsified asphalt cement (Marathon, Houston, TX) was prepared in unleaded gasoline to make a test fluid. Each of the samples were dipped into the test fluid for 10 seconds. The samples were then suspended in a ventilated hood test chamber for 15 minutes allowing the solution to drain/evaporate. After 15 minutes, the samples were cleaned thoroughly with naphtha and then the color was remeasured as described above. The total color change (ΔE) and yellow color change (Ab) were calculated and reported in Tables 10 and 11.

### Chemical Exposure Test Method

EX-1, EX-2, and the White test panel were used as is. For PREP-1 to PREP-5, PREP-8, and CE-1, each of the hard coat layers was applied onto a White test panel of 1 inch×5 inch, respectively, using an acrylate PSA to make a specimen for testing. Various aqueous solution of chemicals, (1% wt. nitric acid, 1% wt. sulfuric acid, 1% wt. hydrochloric acid, or 1% wt. caustic soda) were individually dropped on the hard coat layer surface of each sample with a spot size of 10 millimeter (mm) dimeter. The samples were then placed in an oven for 30 minutes at 85° C. Then, the samples were removed from the oven and cleaned thoroughly with detergent and water and then dried. The chemical resistance rating was defined as follows: 0 means no mark remains; 1 means no or slight color shift, but uneven surface; 3 means color shift, but no slight uneven surface; 4 means color shift and uneven surface; and, 5 means paint melt, break or delamination. The results are reported in Tables 10 and 11.

### Heat Aging Test

EX-2 and the White test panel were used as is. For PREP-1 to PREP-4, and PREP-7, each of the hard coat layers were adhesively attached using acrylic pressure sensitive adhesive layer (about 2 mil or 50 micrometers thick) to the front of a White test panel to make a specimen for testing. A colorimeter (Color i5) was placed in front of the hard coat layer in the construction and used to determine the CIELAB color space. The sample (still adhered to the painted panel) was placed in an oven and heat aged at various temperatures and times and disclosed in Table 9. The sample was removed from the oven and cooled and the CIELAB color space was determined. The difference in the ΔE was determined and reported in Table 9.

### The Accelerated Weathering Aging Test

EX-1, EX-2, and the White test panel was used as is. For PREP-1 to PREP-3, and CE-1, each of the hard coat layers was adhesively attached using acrylic pressure sensitive adhesive layer (about 2 mil or 50 micrometers thick) to the front of White test panel to make a specimen for testing. All of the samples were exposed to 3000 hours of UV exposure. Gloss retention and color changes of the sample after exposure to accelerated weathering conditions were measured in accordance with SAE J2527 standard using a BYK/Haze Gloss instrument to test for gloss and a X-rite Color i5 colorimeter for measuring color change following the manufacturer's instructions.

### PREPARATORY SAMPLES 1-8 (PREP-1 to PREP-8): Preparation of Hard Coat Layer

The polyester polyol-based thermoplastic polyurethane hard coat films were prepared by individually feeding polyester polyol KP-1020, F44-111, DT12, 1,4-CHDM, 1,4-BD, Glycerol, C₃₀₃₁, T292, T479 and DES-W in a co-rotating twin screw extruder according to the amounts listed in Table 3. The extruder used was a 20 mm twin screw extruder (Omega Steer Twin Screw Extruder from Steeramerica Inc., Uniontown, OH) with 60:1 length:diameter and is 10 barrels long. The extruder delivers the thermoplastic polyurethane to a 3.0 cubic centimeter per revolution (CC/REV) gear pump (PEP II Gear Pump from Zenith Power Products LLC, Tomahawk, WI), which meters the polyurethane melt into a heated neck tube which is connected to a 36 cm coat hanger die (available under the trade designation “EDI” from Nordson Extrusion Dies Industries, LLC, Chippewa Falls, WI). The barrel temperatures, die, and neck tube temperatures, are listed in the Table 2 below. The extruded hard coat films (about 3 mils or 76 micrometers) were tested and the results are summarized in Tables 9 and 10.

TABLE 2
Extrusion conditions with extruder run
at 200 revolutions per minute (RPM)

Zone 2: 175° C.
Zone 3: 205° C.
Zone 4: 205° C.
Zone 5: 205° C.
Zone 6: 205° C.
Zone 7: 205° C.
Zone 8: 205° C.
Zone 9: 205° C.
Zone 10: 205° C.
Neck Tube Temp: 180° C.
Die Temp: 190° C.

### Comparative Example 1 (Ce-1)

A two-component polyurethane hard coat composition was prepared as follows: the first reaction component consisted of 8.4 grams of C3031, 23.8 grams of SET 57-2500, 1.0 grams of T405, 0.5 grams of T292, 3.0 grams of CAB 381-01, and 0.4 grams of TEGO-5001 was mixed with 11 grams of PM acetate, 18 grams of butylacetate, 15 grams of MIBK, and 19.65 grams of xylene in a round bottom flask and mixed for an hour at room temperature. Then 26.0 grams of DE N3390 and 0.05 grams of DT12 was added to the flask and mixed for 5 minutes at room temperature. After the mixture was thoroughly mixed, the polyurethane composition was then coated onto a PET liner using a knife coater to produce a coating of approximately 50 microns thickness. The coated film was cured for 2 minutes at 80° C. and 10 minutes at 110° C. in a convection oven. The hard coat film was tested and the results are summarized in Tables 9 and 10.

TABLE 3
Compositions and properties of extruded hard coat layer

| | PREP | PREP | PREP | PREP | PREP | PREP | PREP | PREP |
|---|---|---|---|---|---|---|---|---|
| | 1 | 2 | 3 | 4 | 5 | 6 | 7 | 8 |
| KP-1020, wt. % | 19.74 | 14.66 | 10.71 | 10.71 | 9.85 | 10.71 | 8.83 | 0 |
| F44-111 | 0 | 0 | 0 | 0 | 0 | 0 | 0 | 30.97 |
| DT12, wt. % | 0.05 | 0.05 | 0.05 | 0.05 | 0.05 | 0.05 | 0.05 | 0.03 |
| 1,4-CHDM, wt. % | 25.27 | 27.52 | 29.27 | 29.08 | 29.26 | 29.57 | 30.10 | 0 |
| 1,4-BD | 0 | 0 | 0 | 0 | 0 | 0 | 0 | 14.39 |
| Glycerol, wt. % | 0 | 0 | 0 | 0.21 | 0 | 0 | 0 | 0.24 |
| C3031, wt. % | 0 | 0 | 0 | 0 | 0.79 | 0 | 0 | 0 |
| T292, wt. % | 1.50 | 1.50 | 1.50 | 1.50 | 1.45 | 1.45 | 1.50 | 2.00 |
| T479 wt. % | 1.25 | 1.25 | 1.25 | 1.25 | 1.15 | 1.15 | 1.25 | 1.00 |
| DES-W, wt. % | 52.19 | 55.02 | 57.22 | 57.33 | 57.45 | 57.08 | 58.27 | 51.37 |
| T_{g}, ° C. | 109.8 | 117.0 | 121.8 | 123.3 | 122.6 | 122.2 | 123.5 | 61.6 |

### PREPARATORY SAMPLE 9 (PREP-9): Preparation of Colored Resin Layer

Synthesis of carboxy group-containing (meth)acrylic polymer (Polymer A): In 150 parts by mass of methyl ethyl ketone (MEK), 94 parts by mass of n-butyl acrylate (BA) and 6 parts by mass of acrylic acid (AA) were dissolved to prepare a monomer mixture. After 0.5 parts by mass of 2,2′-azobis(2,4-dimethylvaleronitrile) (AVN) was added as a polymerization initiator to the monomer mixture, and the mixture was reacted at 50° C. for 20 hours in a nitrogen atmosphere to prepare a 33 mass % MEK solution of a carboxy-containing (meth)acrylic polymer (Polymer A). The weight average molecular weight of the Polymer A was about 260000 g/mol, and the glass transition temperature (T_{g}) calculated from the FOX equation was −49° C.

Synthesis of amino group-containing (meth)acrylic polymer (Polymer B): A 40 mass % MEK solution of an amino group-containing (meth)acrylic polymer (Polymer B) was prepared in accordance with the same procedure as for the Polymer A, except for using 94 parts by mass of methyl methacrylate (MMA) and 6 parts by mass of dimethylaminoethyl methacrylate (DMAEMA) as monomers. The weight average molecular weight of the Polymer B was about 120000 g/mol, and the glass transition temperature (T_{g}) calculated from the FOX equation was 68° C.

A colored resin layer having a solid content of 43.0 mass % can be prepared by combining the following ingredients as listed in Table 4.

TABLE 4

| | Solid content of | Parts by mass of |
|---|---|---|
| Ingredient | ingredient (mass %) | ingredient used |
| Polymer A | 33 | 50.2 |
| Polymer B | 40 | 17.6 |
| MIBK | 0.0 | 31.5 |
| S1010 | 100 | 0.2 |
| E5XM | 5 | 0.5 |
| White Paint | 65 | 87.5 |

A heat activated acrylic adhesive can be prepared by combining the following ingredients as listed in Table 5.

TABLE 5

| | Solid content of | Parts by mass of |
|---|---|---|
| Ingredient | ingredient (mass %) | ingredient used |
| Polymer A | 33 | 50.2 |
| Polymer B | 40 | 17.6 |
| S1010 | 100 | 0.2 |
| E5XM | 5 | 0.5 |

The heat-activated acrylic adhesive was coated onto release coated polyethylene terephthalate film. The colored resin layer was coated onto the heat-activated acrylic adhesive with the use of a knife coater on the opposite surface of the adhesive as the release coated polyethylene terephthalate film. The multilayered film was placed on a corrugated cardboard and dried in a hot-air oven at 80° C. for 10 minutes to form a colored resin layer of approximately 40 μm in thickness.

A clear polyurethane layer was applied onto the exposed surface of the colored resin layer. The clear polyurethane layer was prepared by combining the following ingredients as listed in Table 6.

TABLE 6

| | Solid content of | Parts by mass of |
|---|---|---|
| Ingredient | ingredient (mass %) | ingredient used |
| D6260 | 38.7 | 93.8 |
| D28 | 38 | 1.0 |
| 104E | 100 | 0.5 |
| isopropanol | 0 | 4.7 |

A primer layer was applied then applied onto the exposed surface of the clear polyurethane layer. The clear primer layer was prepared by combining the following ingredients as listed in Table 7.

TABLE 7

| | Solid content of | Parts by mass of |
|---|---|---|
| Ingredient | ingredient (mass %) | ingredient used |
| TMS-18 | 30 | 17.2 |
| YP50EK35 | 3835 | 31.6 |
| MEK | 0 | 37.1 |
| Butyl acetate | 0 | 10.4 |
| Distilled water | 0 | 3.6 |
| BYK-355 | 99.9 | 0.1 |

This resulted in a multilayered construction PREP-9 with the following layers as follows:
(1) a clear primer layer (5 micrometer); (2) clear polyurethane interlayer (20 micrometer); (3) color resin layer (60 micrometer); (4) an acrylic heat activated adhesive, and (4) release coated polyethylene terephthalate film.

### Example 1 (Ex-1)

PREP-3 from above was place on a PET carrier web. A multilayered paint film was made by thermally laminating PREPATORY SAMPLES 3 and 9 together at 235° F. (113° C.), wherein the clear primer layer from PREP-9 was contacted with the exposed surface of PREP-3. The nip roll pressure was set at 40 pounds per square inch (psi) and the line speed was 12 feet/minute (3.66 meters/minute). The PET carrier web was stripped off to expose the hard coat layer.

### Example 2 (Ex-2)

A three layer coextruded multilayered paint film was made as follows. The composition as described for PREP 3 was pelletized, by feeding the individual ingredients as summarized in Table 3 into a co-rotating twin screw extruder. The polymerization was completed in the barrels and the polymer melt was delivered to an EUP-10 Econ Underwater Pelletizer (Econ GMbH, Traun, Austria) to form hard coat pellets.

Pellets of a colored polyurethane resin were made by feeding the individual ingredients as summarized in Table 8 into a co-rotating twin screw extruder. The polymerization was completed in the barrels and the polymer melt was delivered to a pelletizer to form colored pellets.

A three layer coextruded film (hard coat, colored polyurethane, and adhesive) was made by three extruders extruding into a single three manifold 10 cm wide custom-made die. A 3 centimeter (cm) single screw extruder (Killion Extruders Inc., Cedar Grove, NJ) was used to convey the hard coat pellets to the multi manifold die at 225° C. The 3 cm Killion single screw extruder was used to convey DES-540/3 to the multi manifold die at 190° C. A 2 cm twin screw extruder (Omega series from Steer America, Uniontown, OH) was used to convey the colored pellets to a 3.0 CC/REV gear pump, which metered the colored pellets to the multi manifold die at 170° C. The three feed streams created three parallel layers 10 cm wide. The hard coat layer was 0.08 mm thick and casted onto a PET liner. The colored layer was 0.10 mm thick and extruded between the adhesive and the hard coat layers. The adhesive layer was 0.03 mm thick and was casted against a silicone cast roll. The three layers were nipped between a silicone covered cast roll and a nip roll conveying PET liner resulting in a multilayered construction having the following layers in order PET/hard coat/colored resin/adhesive/PET. The nip pressure between the cast roll and nip roll was 5 psi. The line speed was 1.5 meters/minute. Before testing, the external PET liners were removed from the construction. The properties of the 3 layer paint film (EX-2) were summarized in Tables 9 and 11.

TABLE 8
Formulation of extruded colored thermoplastic
soft polyurethanes pellets

| MATERIAL | AMOUNT, wt. % |
|---|---|
| F44-111 | 37.68 |
| 1,4-DB | 6.62 |
| DES-W | 29.40 |
| F4202 | 0.032 |
| T292 | 0.31 |
| T571 | 0.45 |
| I1076 | 0.50 |
| White Pigment | 25.00 |

TABLE 9

| | | | | | | | | White | |
|---|---|---|---|---|---|---|---|---|---|
| | | | | | | | | Test | |
| | PREP-1 | PREP-2 | PREP-3 | PREP-4 | PREP-7 | EX-1 | EX-2 | Panel | CE-1 |
| Haze, % | 0.29 | 0.17 | 0.23 | 0.19 | 0.25 | NA | NA | NA | 0.28 |
| 60 degree, GU | 101.1 | 95.1 | 95.0 | 95.2 | 95.4 | 97.5 | 94.1 | 95.5 | 94.5 |
| 20 degree, GU | 87.7 | 85.7 | 86.5 | 85.8 | 86.2 | 88.8 | 76.0 | NA | 85.2 |

Physical properties

| Elongation of 1 inch strip | | 6.30 | 7.87 | 10.97 | 17.32 | 9.58 | NA | NA | NA | 4.2 |
|---|---|---|---|---|---|---|---|---|---|---|
| at room temperature, % | | | | | | | | | | |
| Elongation of 1 inch strip | | 219.63 | 191.96 | 161.52 | 142.90 | 161.20 | NA | NA | NA | 27.6 |
| at 100° C., % | | | | | | | | | | |
| Elongation of 1 inch strip | | 978.76 | 735.80 | 498.50 | 361.78 | 423.01 | NA | NA | NA | 42.7 |
| at 140° C., % | | | | | | | | | | |
| Heat aged 7 days at | | 0.64 | 0.70 | 0.71 | 0.92 | 1.15 | NA | 0.63 | 0.31 | NA |
| 80° C., ΔE | | | | | | | | | | |
| Heat Aged 72 hours at | | 1.58 | 1.24 | 1.32 | 1.11 | 1.10 | NA | 1.06 | NA | NA |
| 105° C., ΔE | | | | | | | | | | |
| Heat Aged 7 days at | | 0.83 | 0.69 | 1.11 | 1.46 | 1.38 | NA | 0.86 | 0.53 | NA |
| 95° C., ΔE | | | | | | | | | | |
| Weather Aging | 60 degree | NA | NA | NA | NA | NA | 95.6 | 93.5 | 94.9 | 94.3 |
| | gloss, GU | | | | | | | | | |
| | ΔE | 0.52 | 0.36 | 0.17 | NA | NA | 0.35 | 1.73 | −0.48 | 0.26 |

NA- not measured

TABLE 10

| EXPOSURE | PREP 1 | PREP 2 | PREP 3 | PREP 4 | PREP 5 | PREP 8 | CE-1 |
|---|---|---|---|---|---|---|---|
| Staining | ΔE = 2.44 | ΔE = 1.99 | ΔE = 0.64 | ΔE = 0.96 | ΔE = 1.06 | ΔE = 3.15 | ΔE = 0.51 |
| | Δb* = 2.32 | Δb* = 1.90 | Δb* = 0.61 | Δb* = 0.91 | Δb* = 1.01 | Δb* = 2.93 | Δb* = 0.23 |
| 1% Nitric | 4 | 3 | 3 | 3 | 3 | NA | 3 |
| Acid | | | | | | | |
| 1% Sulfuric | 0 | 0 | 0 | 0 | 0 | NA | 0 |
| Caustic | 0 | 0 | 0 | 0 | 0 | NA | 0 |
| Soda | | | | | | | |
| 1% HCl | 0 | 0 | 0 | 0 | 0 | NA | 0 |

NA = not measured

PREP 8 was an aliphatic thermoplastic polyurethane having a similar composition as Body Layer 9 in U.S. Pat. No. 10,884,163 (Thakkar, et al.). As shown in Table 10 above, this comparative example of a polyurethane coating layer did not have as good of staining resistance as the hard coat compositions of the present disclosure.

CE-1, a thermosetting polyurethane, although having good staining characteristics, does not have good thermoforming properties as shown in Table 9 above, where the elongation, especially raised temperatures, was not as high as the hard coat compositions of the present disclosure.

TABLE 11

| | | | White Test |
|---|---|---|---|
| EXPOSURE | EX-1 | EX-2 | Panel |
| Staining | ΔE = 0.78 | ΔE = 0.68 | ΔE = 1.76 |
| | Δb* = 0.84 | Δb* = 0.74 | Δb* = 1.58 |
| 1% Nitric | 3 | 4 | 5 |
| Acid | | | |
| 1% Sulfuric | 0 | 0 | 3 |
| Caustic | 0 | 0 | 3 |
| Soda | | | |
| 1% HCl | 0 | 0 | 0 |

NA = not measured

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A multilayered paint film comprising in order:
(i) a hard coat layer comprising a thermoplastic polyurethane and having a hard segment content of 80 percent by weight or greater, wherein the thermoplastic polyurethane is a reaction product of:
a) a diisocyanate;
b) a polyol optionally comprising a cyclic structure; and
c) a chain extender, wherein at least one of the polyol or the chain extender comprises at least one side chain and at least one of the diisocyanate or the chain extender comprises a cyclic structure;
(ii) a colored polymeric resin layer comprising a colorant, wherein the colored polymeric resin layer is 50-250 micrometers thick; and
(iii) an adhesive layer, wherein the adhesive layer comprises a pressure sensitive adhesive or a hotmelt adhesive.

2. The multilayered paint film of claim 1, further comprising a primer layer, wherein the primer layer is disposed between the hard coat layer and the colored resin layer.

3. The multilayered paint film of claim 1, wherein the colored polymeric resin layer is in intimate contact with the hard coat layer.

4. The multilayered paint film of claim 1, wherein the colored polymeric resin layer comprises at least 2% by weight of the colorant.

5. The multilayered paint film of claim 1, wherein the colorant comprises at least one of organic pigments, inorganic pigments, metallic flakes, and mica pearls.

6. The multilayered paint film of claim 1, wherein the multilayered paint film comprises a second colored polymeric resin layer comprising a second colorant.

7. The multilayered paint film of claim 1, claims, further comprising a release liner, wherein the release liner is disposed on at least one outermost major surface of the multilayered paint film.

8. The multilayered paint film of claim 1, wherein the pressure sensitive adhesive comprises from at least one of an (meth)acrylic, a vinyl acetate, a polyurethane, a rubber, and a silicone.

9. The multilayered paint film of claim 1, wherein the hotmelt adhesive comprises from at least one of a polyurethane, an (meth)acrylic, and a silicone.

10. The multilayered paint film of claim 1, wherein the reaction product further comprises a crosslinker at 10% or less in number-OH equivalent.

11. The multilayered paint film of claim 1, wherein the hard segment content is 85 percent by weight or greater.

12. (canceled)

13. The multilayered paint film of claim 1, wherein the diisocyanate comprises a cyclic structure.

14. The multilayered paint film of claim 1, wherein the chain extender comprises a diol, a polyester diol, a poly(oxy)alkylenediol with an oxyalkylene group having 2 to 4 carbon atoms, or combinations thereof.

15. The multilayered paint film of claim 1, wherein the chain extender comprises a cyclic structure.

16. The multilayered paint film of claim 1, wherein the polyol is selected from the group consisting of: polyester polyols, polycaprolactone polyols, polycarbonate polyols, polyether polyols, polyolefin polyols, fatty acid dimer diols, and copolymers and mixtures thereof.

17. (canceled)

18. The multilayered paint film of claim 1, wherein the polyol has a structure of the following Formula (I): 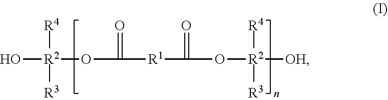
wherein R¹ and R² are independently selected from (C₁-C₄₀)alkylene, (C₂-C₄₀)alkenylene, (C₄-C₂₀) arylene, (C₁-C₄₀) acylene, (C₄-C₂₀) cycloalkylene, (C₄-C₂₀) aralkylene, or (C₁-C₄₀)alkoxyene, which may be substituted or unsubstituted; and R³ and R⁴ are independently selected from —H, (C₁-C₄₀)alkyl, (C₂-C₄₀)alkenyl, (C₄-C₂₀) aryl, (C₁-C₂₀) acyl, (C₄-C₂₀) cycloalkyl, (C₄-C₂₀) aralkyl, and (C₁-C₄₀)alkoxy, which may be substituted or unsubstituted; and n is a positive integer greater than or equal to 1.

19. The multilayered paint film of claim 1, wherein the multilayered paint film is substantially free of solvent.

20. (canceled)

21. (canceled)

22. (canceled)

23. A method of applying color to a part, the method comprising,
a. providing the part, wherein the part comprises a metal, a plastic, or a composite; and
b. thermoforming the multilayered paint film of claim 1, around the part.

24. The method of claim 23, wherein the thermoforming is dual vacuum thermoforming.

25. The method of claim 23, wherein the part is for a vehicle or vehicle part.

26. (canceled)
